(19) United States
(12) Patent Application Publication
(10) Pub. No.: US 2021/0053277 A1
(43) Pub. Date: Feb. 25, 2021

(54) SHAPING APPARATUS

(71) Applicant: MIMAKI ENGINEERING CO., LTD., Nagano (JP)

(72) Inventor: Kunio Hakkaku, NAGANO (JP)

(73) Assignee: MIMAKI ENGINEERING CO., LTD., Nagano (JP)

(21) Appl. No.: 16/995,773

(22) Filed: Aug. 17, 2020

(30) Foreign Application Priority Data
Aug. 21, 2019 (JP) 2019-151093

(51) Int. Cl. B29C 64/124; B29C 64/245; B29C 64/209; B29C 64/218; B29C 64/188

(52) U.S. Cl. CPC B29C 64/124; B29C 64/245; B33Y 30/00; B29C 64/218; B29C 64/188; B29C 64/209

(57) ABSTRACT

A shaping apparatus that shapes a three-dimensional object by a layered shaping method includes a shaping table on which the three-dimensional object is shaped, an inkjet head that ejects an ink toward the shaping table, and a flattening roller that removes a part on an upper surface side of the ink ejected from the inkjet head to flatten an upper surface of the ink and adjust a thickness of an ink layer. On the outer peripheral surface of the flattening roller, an ink adhering portion including an ink adhering surface to which the ink adheres when flattening the upper surface of the ink, and a non-ink adhering portion including a liquid repellent surface which is a surface having liquid repellency are provided.

### CROSS REFERENCE TO RELATED APPLICATIONS

This application claims the priority benefit of Japanese Patent Application No. 2019-151093, filed on Aug. 21, 2019. The entirety of the above-mentioned patent application is hereby incorporated by reference herein and made a part of this specification.

### TECHNICAL FIELD

The present disclosure relates to a shaping apparatus that shapes a three-dimensional object by a layered shaping method.

### DESCRIPTION OF THE BACKGROUND ART

Conventionally, a three-dimensional object shaping apparatus that shapes a three-dimensional object by a layered shaping method is known (see e.g., Japanese Unexamined Patent Publication No. 2018-122479, Patent Literature 1). The three-dimensional object shaping apparatus described in Japanese Unexamined Patent Publication No. 2018-122479 includes an ejection unit, a main scan driving unit that causes the ejection unit to perform a main scan, and a shaping table on which a three-dimensional object is shaped. The ejection unit includes a plurality of inkjet heads that eject ultraviolet curable ink toward the shaping table, an ultraviolet light source that irradiates the ink ejected from the inkjet head with ultraviolet light to cure the ink, and a flattening roller unit.

In the three-dimensional object shaping apparatus described in Japanese Unexamined Patent Publication No. 2018-122479, the flattening roller unit includes a flattening roller that removes a part of the upper surface side of the ink ejected from the inkjet head to flatten the upper surface of the ink and make the thickness of the ink layer constant, a blade that scrapes off the ink adhered to the surface of the flattening roller, a storage unit that temporarily stores the ink scraped off by the blade, and a suction pipe that suctions the ink stored in the storage unit. The suction pipe is connected to a suction device through a tube.

Patent Literature 1: Japanese Unexamined Patent Publication No. 2018-122479

In the three-dimensional object shaping apparatus described in Japanese Unexamined Patent Publication No. 2018-122479, for example, a three-dimensional object is shaped by the multi-pass method in order to improve the resolution or average the ejection characteristics of the nozzles of the inkjet head. In this case, in the operation of forming one ink layer, the ejection unit performs the main scan a plurality of times with respect to each position of the three-dimensional object being shaped. In each main scan, for example, the flattening roller flattens the upper surface of the ink ejected from the inkjet head, and the ultraviolet light source irradiates the ink with flattened upper surface with ultraviolet light to cure the ink.

When a three-dimensional object is shaped by the multi-pass method in the three-dimensional object shaping apparatus described in Japanese Unexamined Patent Publication No. 2018-122479, it became clear by the review of the inventors of the present application that the upper surface of the ink that has already cured and the flattening roller may come into contact with each other. Furthermore, it became clear by the review of the inventors of the present application that, when the upper surface of the ink that has already cured and the flattening roller come into contact with each other, a part of the cured ink may be scraped off by the flattening roller, and flake-like shavings may be produced. When shavings are produced, shavings may accumulate on the blade thus hindering the ink scraping operation of the blade and causing clogging of the suction pipe that suctions the ink stored in the storage unit with shavings, and thus may arise problems in the flattening operation of the flattening roller.

Furthermore, in a case where the upper surface of the cured ink and the flattening roller come into contact with each other, when the frictional force between the upper surface of the cured ink and the flattening roller becomes strong, for example, an abnormal vibration of the flattening roller caused by stick slip may occur and the three-dimensional object in the middle of shaping may deform. Moreover, in a case where the upper surface of the cured ink and the flattening roller come into contact with each other, when the frictional force between the upper surface of the cured ink and the flattening roller becomes strong, the three-dimensional object in the middle of shaping may separate from the shaping table. That is, in a case where the three-dimensional object is shaped by the multi-pass method in the three-dimensional object shaping apparatus described in Japanese Unexamined Patent Publication No. 2018-122479, the upper surface of the cured ink and the flattening roller may come into contact with each other thus arising various problems, and hence shaping failures of the three-dimensional object may occur.

The present disclosure thus provides a shaping apparatus capable of suppressing the occurrence of shaping failures of the three-dimensional object when a three-dimensional object is shaped by a multi-pass method, even in a case where the upper surface of the cured ink and a flattening roller come into contact with each other.

### SUMMARY

A first aspect of the present disclosure is a shaping apparatus that shapes a three-dimensional object by a layered shaping method, and the shaping apparatus includes: a shaping table on which the three-dimensional object is shaped; an inkjet head that ejects an ink toward the shaping table; a flattening roller that removes a part on an upper surface side of the ink ejected from the inkjet head to flatten an upper surface of the ink and adjust a thickness of an ink layer; and an ink removing portion that removes the ink adhered to an outer peripheral surface of the flattening roller from the outer peripheral surface of the flattening roller. On the outer peripheral surface of the flattening roller, an ink adhering portion including an ink adhering surface to which the ink adheres when flattening the upper surface of the ink, and a non-ink adhering portion including a liquid repellent surface which is a surface having liquid repellency are provided.

Furthermore, a second aspect of the present disclosure is a shaping apparatus that shapes a three-dimensional object by a layered shaping method, and the shaping apparatus includes: a shaping table on which the three-dimensional object is shaped; an inkjet head that ejects an ink toward the shaping table; a flattening roller that removes a part on an upper surface side of the ink ejected from the inkjet head to flatten an upper surface of the ink and adjust a thickness of an ink layer; and an ink removing portion that removes the ink adhered to an outer peripheral surface of the flattening roller from the outer peripheral surface of the flattening roller. On the outer peripheral surface of the flattening roller, an ink adhering portion including an ink adhering surface to which the ink adheres when flattening the upper surface of the ink, and a non-ink adhering portion including a recess that is depressed toward an inner side in a radial direction of the flattening roller are provided.

In the shaping apparatus of the present disclosure, the non-ink adhering portion including a liquid repellent surface, which is a surface having liquid repellency, or a non-ink adhering portion including a recess that is depressed toward an inner side in a radial direction of the flattening roller are provided on the outer peripheral surface of the flattening roller. Thus, in the present disclosure, even if the upper surface of the cured ink and the flattening roller come into contact with each other, a part of the cured ink is less likely to be scraped off by the non-ink adhering portion. Therefore, in the present disclosure, even if the upper surface of the cured ink and the flattening roller come into contact with each other, a part of the cured ink is less likely to be scraped off by the flattening roller. Thus, in the present disclosure, even if the upper surface of the cured ink and the flattening roller come into contact with each other, production of shavings can be suppressed.

Furthermore, in the present disclosure, the frictional force between the upper surface of the ink and the flattening roller can be reduced since the non-ink adhering portion is provided on the outer peripheral surface of the flattening roller. Therefore, in the present disclosure, even if the upper surface of the cured ink and the flattening roller come into contact with each other, generation of abnormal vibration of the flattening roller, deformation of the three-dimensional object being shaped, and the separation from the shaping table of the three-dimensional object being shaped can be suppressed. As a result, in the present disclosure, even when the three-dimensional object is shaped by the multi-pass method and the upper surface of the cured ink and the flattening roller come into contact with each other, the occurrence of shaping failures of the three-dimensional object can be suppressed.

In the present disclosure, the ink adhering surface and the liquid repellent surface are preferably disposed on the same surface of the outer peripheral surface of the flattening roller. With this configuration, since the recess (depression) is not provided on the outer peripheral surface of the flattening roller, the uncured ink does not enter the recess provided on the outer peripheral surface of the flattening roller. Therefore, for example, even when the shaping apparatus includes a plurality of inkjet heads that eject different inks, it is possible to prevent different inks from being mixed when shaping the three-dimensional object.

In the present disclosure, for example, the ink adhering surface is a metal surface.

In the present disclosure, on the outer peripheral surface of the flattening roller, the ink adhering portion and the non-ink adhering portion adjacent to each other are preferably provided in a spiral shape along an axial direction of the flattening roller. According to such a configuration, the processing of the flattening roller when forming the non-ink adhering portion on the flattening roller can be easily performed. Furthermore, when configured in such a manner, for example, when scraping off the ink adhered to the outer peripheral surface of the flattening roller by a blade similar to the blade described in Japanese Unexamined Patent Publication No. 2018-122479 described above, the tip of the blade that comes into contact with the outer peripheral surface of the flattening roller can be brought into contact with the ink adhering portion in the entire region in the circumferential direction of the flattening roller. Therefore, when the non-ink adhering portion is a liquid repellent surface, it becomes possible to prevent the liquid repellent surface from being scraped off by the tip of the blade. Moreover, when the non-ink adhering portion is a recess, it becomes possible to prevent the tip of the blade from fitting in the recess.

In the present disclosure, the ink adhering portion and the non-ink adhering portion may be arranged in a checkered pattern. Further, in the present disclosure, the ink adhering portion and the non-ink adhering portion may be alternately arranged in an axial direction of the flattening roller. When the ink adhering portion and the non-ink adhering portion are alternately arranged in the axial direction of the flattening roller, for example, the tip of the blade that comes into contact with the outer peripheral surface of the flattening roller can be brought into contact with the ink adhering portion in the entire region in the circumferential direction of the flattening roller when scraping off the ink adhered to the outer peripheral surface of the flattening roller by the blade similar to the blade described in Japanese Unexamined Patent Publication No. 2018-122479. Therefore, when the non-ink adhering portion is a liquid repellent surface, it becomes possible to prevent the liquid repellent surface from being scraped off by the tip of the blade. Moreover, when the non-ink adhering portion is a recess, it becomes possible to prevent the tip of the blade from fitting in the recess.

In the present disclosure, the ink adhering portion and the non-ink adhering portion may be alternately arranged in a circumferential direction of the flattening roller. Furthermore, in the present disclosure, the shaping apparatus includes, for example, at least two inkjet heads that eject different inks.

As described above, in the shaping apparatus of the present disclosure, when the three-dimensional object is shaped by the multi-pass method and the upper surface of the cured ink and the flattening roller are brought into contact with each other, the occurrence of shaping failures of the three-dimensional object can be suppressed.

### BRIEF DESCRIPTION OF THE DRAWINGS

FIG. 1 is a schematic view describing a structure of a shaping apparatus according to an embodiment of the present disclosure.

FIG. 2 is a schematic view describing a configuration of a flattening roller unit shown in FIG. 1.

FIG. 3 is a side view of a part of a flattening roller shown in FIG. 1.

FIG. 4A is a schematic diagram showing an experimental state for confirming the effect of the shaping apparatus shown in FIG. 1, and FIG. 4B is a graph showing the experimental results.

FIG. 5 is a side view of a flattening roller according to another embodiment of the present disclosure.

FIG. 6 is an enlarged view describing a configuration of portion E of FIG. 5.

FIG. 7 is a cross-sectional view describing a configuration of the flattening roller shown in FIG. 5.

FIGS. 8A and 8B are enlarged views describing the configuration of the flattening roller according to another embodiment of the present disclosure.

FIGS. 9A and 9B are enlarged views describing the configuration of the flattening roller according to another embodiment of the present disclosure.

FIGS. 10A and 10B are enlarged views describing the configuration of the flattening roller according to another embodiment of the present disclosure.

### DESCRIPTION OF EMBODIMENTS

Hereinafter, an embodiment of the present disclosure will be described with reference to the drawings.

(Structure of Shaping Apparatus)

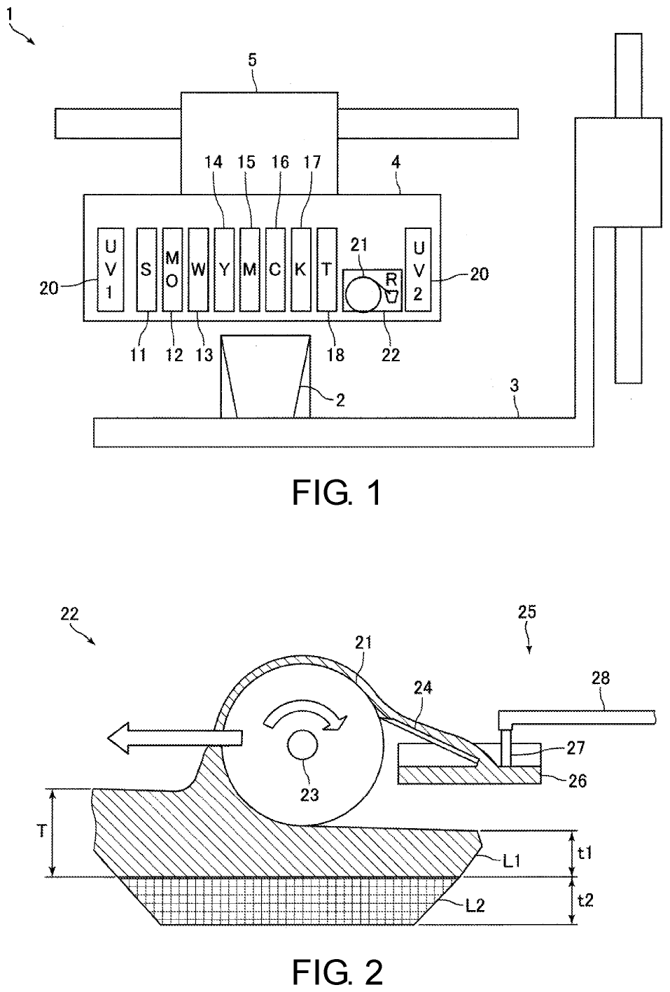

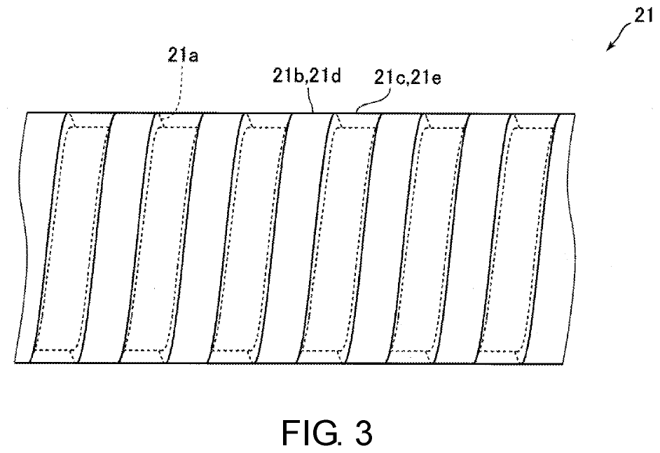

FIG. 1 is a schematic view describing a structure of a shaping apparatus 1 according to an embodiment of the present disclosure. FIG. 2 is a schematic view describing a configuration of a flattening roller unit 22 shown in FIG. 1. FIG. 3 is a side view of a part of a flattening roller 21 shown in FIG. 1.

The shaping apparatus 1 of the present embodiment is a commercial inkjet printer that shapes a three-dimensional object 2 by a layered shaping method. The shaping apparatus 1 includes a shaping table 3 on which the three-dimensional object 2 is shaped, an ejection unit 4 for shaping the three-dimensional object 2, and a carriage 5 on which the ejection unit 4 is mounted. The ejection unit 4 is disposed above the shaping table 3. The shaping apparatus 1 also includes a carriage drive mechanism that moves the carriage 5 in the main scanning direction, a shaping table up-down moving mechanism that moves the shaping table 3 up and down, and a shaping table drive mechanism that moves the shaping table 3 in a sub scanning direction orthogonal to the main scanning direction.

The ejection unit 4 includes a plurality of inkjet heads 11 to 18 that eject ink toward the shaping table 3. The ejection unit 4 of the present embodiment includes eight inkjet heads 11 to 18. The inkjet heads 11 to 18 ejects ink toward the lower side. The ink ejected from the inkjet heads 11 to 18 is an ultraviolet curable ink. The ejection unit 4 also includes two ultraviolet irradiators 20 that irradiate the ultraviolet curable ink ejected from the inkjet heads 11 to 18 toward the shaping table 3 with ultraviolet light to cure the ink, and a flattening roller unit 22 having a flattening roller 21 that flattens the upper surface of the ink by removing a part of the upper surface side (front surface side) of the ink ejected from the inkjet heads 11 to 18 toward the shaping table 3.

The ultraviolet irradiator 20, the inkjet head 11, the inkjet head 12, the inkjet head 13, the inkjet head 14, the inkjet head 15, the inkjet head 16, the inkjet head 17, the inkjet head 18, the flattening roller unit 22 and the ultraviolet irradiator 20 are mounted on the carriage 5 in this order from one side to the other side in the main scanning direction. The ultraviolet irradiator 20 is a UV LED, a metal halide lamp, a mercury lamp, or the like. The ultraviolet irradiator 20 of the present embodiment is a UV LED.

The inkjet head 11 ejects a support ink (support material) for supporting the three-dimensional object 2. The inkjet head 12 ejects a shaping ink (shaping material). The inkjet head 13 ejects white ink. The inkjet heads 14 to 17 eject colored ink (color ink). In the present embodiment, the color of the ink ejected from the inkjet head 14 is yellow, the color of the ink ejected from the inkjet head 15 is magenta, the color of the ink ejected from the inkjet head 16 is cyan, and the color of the ink ejected from the inkjet head 17 is black. The inkjet head 18 ejects transparent ink (clear ink). That is, the ejection unit 4 includes eight inkjet heads 11 to 18 that eject different inks.

The flattening roller unit 22 includes a rotation shaft 23 to which the flattening roller 21 is fixed, a blade 24 serving as an ink removing portion that removes the ink adhered to the outer peripheral surface of the flattening roller 21 when flattening the upper surface of the ink ejected toward the shaping table 3 from the outer peripheral surface of the flattening roller 21, and an ink collecting portion 25 that collects the ink removed from the outer peripheral surface of the flattening roller 21 by the blade 24. The flattening roller unit 22 also includes a roller rotating mechanism that rotates the flattening roller 21, and a roller up-down moving mechanism that moves the flattening roller 21 up and down.

The blade 24 is disposed at a position where the tip of the blade 24 contacts the outer peripheral surface of the flattening roller 21. When the flattening roller 21 rotates, the blade 24 scrapes off and removes the ink adhered to the outer peripheral surface of the flattening roller 21. The ink collecting portion 25 includes an ink container 26 in which the ink removed from the outer peripheral surface of the flattening roller 21 by the blade 24 is stored, and a suction pipe 27 for suctioning the ink from the ink container 26. The suction pipe 27 is connected to a suction device through a tube 28.

The flattening roller 21 is made of, for example, a steel-based metal material. The flattening roller 21 of the present embodiment is made of stainless steel. The flattening roller 21 is formed in a thick cylindrical shape. As shown in FIG. 2, when forming one layer of ink (ink layer) L1 that forms a part of the three-dimensional object 2, assuming that the thickness of the ink ejected from the inkjet heads 11 to 18 is T, the flattening roller 21 removes an amount corresponding to a thickness (T−t2) of the uncured ink before the ultraviolet light is irradiated to flatten the upper surface of the ink so that a thickness t1 of the uncured ink layer L1 before the ultraviolet light is irradiated becomes the same thickness as a thickness t2 of a layer of ink (ink layer) L2 disposed on the lower side of the ink layer L1 and irradiated with ultraviolet light and cured.

That is, the flattening roller 21 adjusts the thickness of the ink layer by removing a part of the upper surface side of the ink ejected from the inkjet heads 11 to 18. Specifically, the flattening roller 21 removes a part of the upper surface side of the ink ejected from the inkjet heads 11 to 18 to make the thickness of the ink layer constant. The thickness T of the ink ejected from the inkjet heads 11 to 18 is, for example, 20 μm in design, and in this case, the thickness (T−t2) of the ink removed by the flattening roller 21 is at most 4 μm in design. Furthermore, in this case, the outer diameter of the flattening roller 20 is 20 mm.

In the present embodiment, the shaping apparatus 1 shapes the three-dimensional object 2 by the multi-pass method. That is, when forming one ink layer that forms a part of the three-dimensional object 2, the ejection unit 4 performs a main scan a plurality of times with respect to each position of the three-dimensional object 2 during shaping. In each main scan among the plurality of main scans, the flattening roller 21 flattens the upper surface of the ink ejected from the inkjet heads 11 to 18, and the ultraviolet irradiator 20 irradiates the ink with flattened upper surface with ultraviolet light to cure the ink.

On the outer peripheral surface (surface on the outer peripheral side) of the flattening roller 21, there is formed a recess 21a which is depressed from the outer peripheral surface of the flattening roller 21 toward the inner side in the radial direction of the flattening roller 21 (see FIG. 3). The recess 21a is formed in a spiral shape that advances while rotating along the axial direction of the flattening roller 21. That is, a screw-shaped recess 21a is formed on the outer peripheral surface of the flattening roller 21. The recess 21a may be formed in a single-threaded screw shape or a double-threaded screw shape. Furthermore, in the present embodiment, the cross-sectional shape of the recess 21a is a rectangular shape, but the cross-sectional shape of the recess 21a may be a triangular shape.

The recess 21a is filled with fluorocarbon resin such as polytetrafluoroethylene (PTFE) or a material having liquid repellency (water repellency) such as polyethylene or silicone. In the present embodiment, the PTFE is filled in the recess 21a. A part where the recess 21a is not formed in the outer peripheral surface of the flattening roller 21 is covered with a metal coating formed by plating. In the present embodiment, a part where the recess 21a is not formed in the outer peripheral surface of the flattening roller 21 is covered with a chrome coating formed by chrome plating. That is, a part where the recess 21a is not formed in the outer peripheral surface of the flattening roller 21 is a metal surface.

In the present embodiment, a part where the recess 21a is not formed in outer peripheral surface of the flattening roller 21 is an ink adhering surface 21b to which the ink adheres when the flattening roller 21 flattens the upper surface of the ink. On the other hand, the surface of the PTEF filled in the recess 21a (i.e., a part excluding the ink adhering surface 21b in the outer peripheral surface of the flattening roller 21) is a liquid repellent surface 21c having liquid repellency. The ink adhering surface 21b and the liquid repellent surface 21c are disposed on the same surface of the outer peripheral surface of the flattening roller 21. That is, the outer diameter of the part of the flattening roller 21 where the ink adhering surface 21b is formed is equal to the outer diameter of the part of the flattening roller 21 where the liquid repellent surface 21c is formed.

When the upper surface of the ink is flattened by the flattening roller 21, the uncured ink does not adhere to the liquid repellent surface 21c. Furthermore, the cured ink does not adhere to the liquid repellent surface 21c even if the upper surface of the cured ink and the outer peripheral surface of the flattening roller 21 come into contact with each other when shaping the three-dimensional object 2 by the multi-pass method. That is, on the outer peripheral surface of the flattening roller 21, an ink adhering portion 21d including the ink adhering surface 21b and a non-ink adhering portion 21e including the liquid repellent surface 21c are formed. Specifically, on the outer peripheral surface of the flattening roller 21, the ink adhering portion 21d and the non-ink adhering portion 21e that are adjacent to each other are formed in a spiral shape along the axial direction of the flattening roller 21. The ratio of the area occupied by the liquid repellent surface 21c on the outer peripheral surface of the flattening roller 21 is, for example, in the range of 30% to 50%.

When manufacturing the flattening roller 21, first, the recess 21a is formed by cutting or the like on the outer peripheral surface of a thick cylindrical member that is to become a raw material of the flattening roller 21. Thereafter, the entire outer peripheral surface of the flattening roller 21 is coated with PTFE by vapor deposition or the like so that the recess 21a is filled with PTFE. Then, the outer peripheral surface of the flattening roller 21 is polished until the surface of the part where the recess 21a is not formed in the outer peripheral surface of the flattening roller 21 is exposed. Then, chrome plating is performed to form a chrome coating on the part where the recess 21a is not formed in the outer peripheral surface of the flattening roller 21. Thereafter, the chrome coating formed on the part where the recess 21a is not formed in the outer peripheral surface of the flattening roller 21 is polished to complete the flattening roller 21.

(Main Effects of the Present Embodiment)

As described above, in the present embodiment, the non-ink adhering portion 21e including the liquid repellent surface 21c, which is a surface having liquid repellency, is formed on the outer peripheral surface of the flattening roller 21. Therefore, in the present embodiment, even if the upper surface of the cured ink and the flattening roller 21 come into contact with each other when shaping the three-dimensional object 2 by the multi-pass method, a part of the cured ink is less likely to be scraped off by the non-ink adhering portion 21e. Therefore, in the present embodiment, even if the upper surface of the cured ink and the flattening roller 21 come into contact with each other, a part of the cured ink is less likely to be scraped off by the flattening roller 21. Thus, in the present embodiment, even if the upper surface of the cured ink and the flattening roller 21 come into contact with each other, production of shavings can be suppressed.

Furthermore, in the present embodiment, the frictional force between the upper surface of the ink and the flattening roller 21 can be reduced since the non-ink adhering portion 21e is formed on the outer peripheral surface of the flattening roller 21. Therefore, in the present embodiment, even if the upper surface of the cured ink and the flattening roller 21 come into contact with each other, generation of abnormal vibration of the flattening roller 21, deformation of the three-dimensional object 2 being shaped, and the separation from the shaping table 3 of the three-dimensional object 2 being shaped can be suppressed. As a result, in the present embodiment, even when the three-dimensional object 2 is shaped by the multi-pass method and the upper surface of the cured ink and the flattening roller 21 come into contact with each other, the occurrence of shaping failures of the three-dimensional object 2 can be suppressed.

In the present embodiment, the ink adhering surface 21b and the liquid repellent surface 21c are disposed on the same surface of the outer peripheral surface of the flattening roller 21. Thus, in the present embodiment, the uncured ink does not enter the recess 21a formed on the outer peripheral surface of the flattening roller 21. Therefore, in the present embodiment, even when the shaping apparatus 1 includes eight inkjet heads 11 to 18 that eject different inks, it is possible to prevent different inks from being mixed when shaping the three-dimensional object 2.

In the present embodiment, the ink adhering surface 21b, which is a metal surface, is formed in a spiral shape that advances while rotating along the axial direction of the flattening roller 21. Thus, in the present embodiment, when scraping off the ink adhered to the outer peripheral surface of the flattening roller 21 with the blade 24, the tip of the blade 24 that comes into contact with the outer peripheral surface of the flattening roller 21 contacts the ink adhering portion 21b over the entire region in the circumferential direction of the flattening roller 21. Therefore, in the present embodiment, it is possible to prevent the PTFE forming the liquid repellent surface 21c from being scraped off by the tip of the blade 24.

In the present embodiment, the recess 21a is formed in a spiral shape that advances while rotating along the axial direction of the flattening roller 21. Therefore, in the present embodiment, the processing of the flattening roller 21 when forming the recess 21a in the flattening roller 21 can be easily performed.

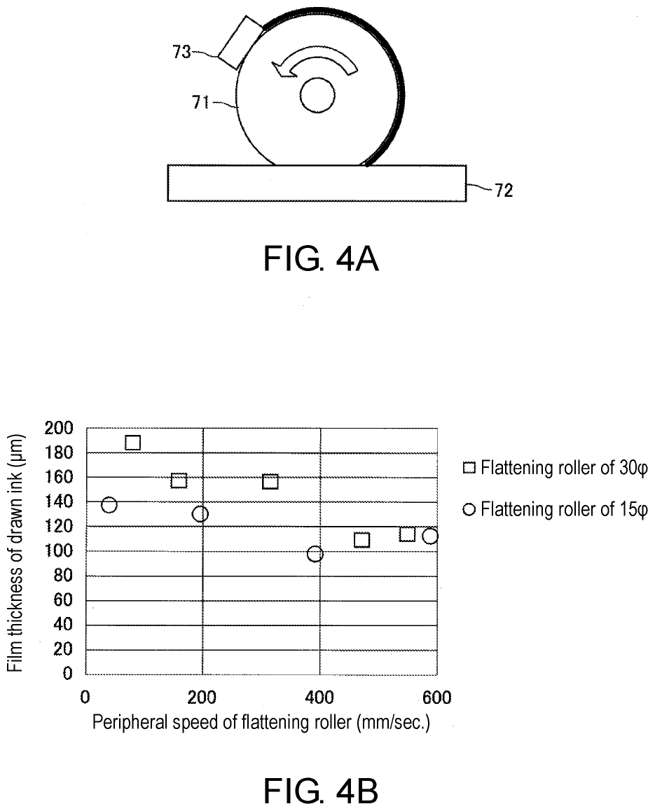

According to the experimental results of the inventor of the present application, even if the non-ink adhering portion 21e is formed on the outer peripheral surface of the flattening roller 21, it is assumed that a part of the upper surface side of the ink ejected from the inkjet heads 11 to 18 can be sufficiently removed by the flattening roller 21. In the experiment, as shown in FIG. 4A, a lower end of the flattening roller 71 (i.e., flattening roller 71 in which the entire outer peripheral surface is the ink adhering portion 21d) in which the non-ink adhering portion 21e is not formed on the outer peripheral surface was disposed in the ink container 72 filled with ink, the flattening roller 71 was rotated at a predetermined rotation speed, and the weight of the ink drawn up from the ink container 72 by the flattening roller 71 was measured.

The weight of the ink drawn up from the ink container 72 by the flattening roller 71 was measured by the weight of the ink absorbed by an ink absorbing material 73 that comes into contact with the outer peripheral surface of the flattening roller 71 on the upper end side of the flattening roller 71. Furthermore, the film thickness of the ink drawn up by the flattening roller 71 from the ink container 72 on the outer peripheral surface of the flattening roller 71 was calculated based on the weight of the ink drawn up by the flattening roller 71 from the ink container 72. In the experiment, a flattening roller 71 having an outer diameter of 30 mm and a flattening roller 71 having an outer diameter of 15 mm were used.

The results of the experiment are shown in FIG. 4B. As shown in FIG. 4B, the film thickness of the ink drawn up by the flattening roller 71 from the ink container 72 on the outer peripheral surface of the flattening roller 71 was at least about 100 μm. As described above, the thickness of the ink removed by the flattening roller 21 having an outer diameter of 20 mm (T−t2) is 4 μm at most in design, and thus taking the experiment results into consideration, even if the non-ink adhering portion 21e is formed on the outer peripheral surface of the flattening roller 21, as described above, it is assumed that a part of the upper surface side of the ink ejected from the inkjet heads 11 to 18 can be sufficiently removed by the flattening roller 21.

(First Modified Example of Flattening Roller)

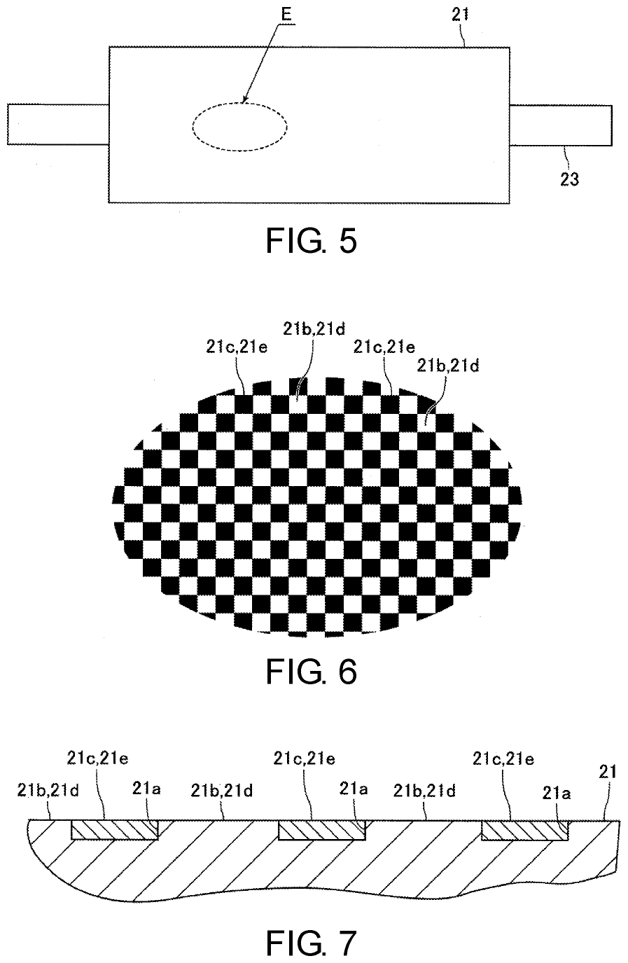

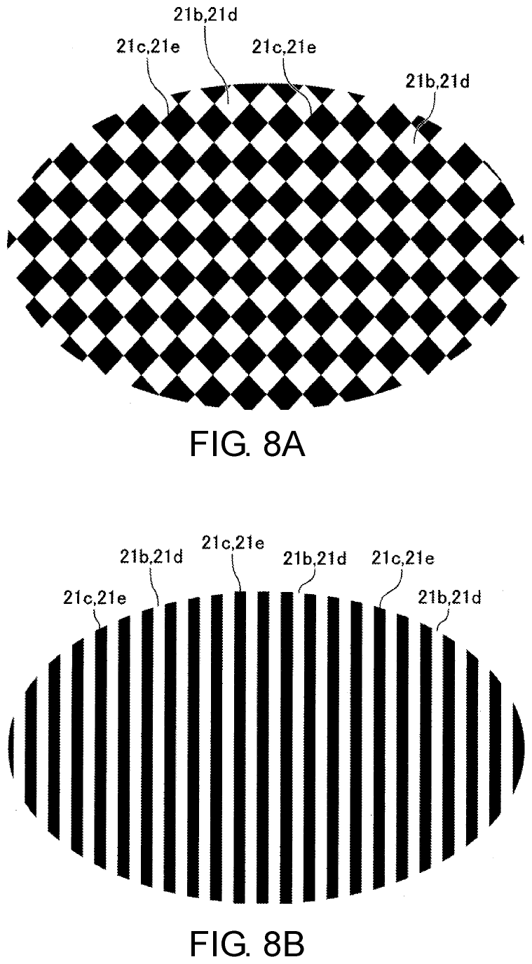

FIG. 5 is a side view of the flattening roller 21 according to another embodiment of the present disclosure. FIG. 6 is an enlarged view describing a configuration of portion E in FIG. 5. FIG. 7 is a cross-sectional view describing a configuration of the flattening roller 21 shown in FIG. 5. FIGS. 8A to 10B are enlarged views describing the configuration of the flattening roller 21 according to another embodiment of the present disclosure. In FIGS. 8A to 10B, the configuration of the part corresponding to portion E of 5 is shown.

As shown in FIG. 6, a plurality of ink adhering surfaces 21b (white parts in FIG. 6) and a plurality of liquid repellent surfaces 21c (black parts in FIG. 6) formed on the outer peripheral surface of the flattening roller 21 may be arranged in a checkered pattern. That is, the ink adhering portions 21d and the non-ink adhering portions 21e may be arranged in a checkered pattern. In a modified example shown in FIG. 6, the ink adhering portions 21d and the non-ink adhering portions 21e are alternately arranged in the axial direction of the flattening roller 21, and are alternately arranged in the circumferential direction of the flattening roller 21. In this case, a plurality of recesses 21a (see FIG. 7) are formed in a checkered pattern on the outer peripheral surface of the flattening roller 21. Furthermore, in this case, the ink adhering surface 21b and the non-ink adhering portion 21e are formed in, for example, a rectangular shape. Specifically, the ink adhering surface 21b and the non-ink adhering portion 21e are formed in a square shape.

Moreover, when the ink adhering portion 21d and the non-ink adhering portion 21e are arranged in a checkered pattern, as shown in FIG. 8A, the ink adhering portion 21d and the non-ink adhering portion 21e may be alternately arranged in a direction inclined with respect to the axial direction of the flattening roller 21 and the circumferential direction of the flattening roller 21.

Furthermore, as shown in FIG. 8B, a plurality of ink adhering surfaces 21b (white parts in FIG. 8B) and a plurality of liquid repellent surfaces 21c (black parts in FIG. 8B) formed on the outer peripheral surface of the flattening roller 21 may be alternately arranged in the axial direction of the flattening roller 21. That is, the ink adhering portions 21d and the non-ink adhering portions 21e may be alternately arranged in the axial direction of the flattening roller 21. In the modified example shown in FIG. 8B, the ink adhering portion 21d and the non-ink adhering portion 21e are formed in an annular shape along the circumferential direction of the flattening roller 21. In this case, a plurality of annular recesses 21a are formed on the outer peripheral surface of the flattening roller 21 along the circumferential direction of the flattening roller 21.

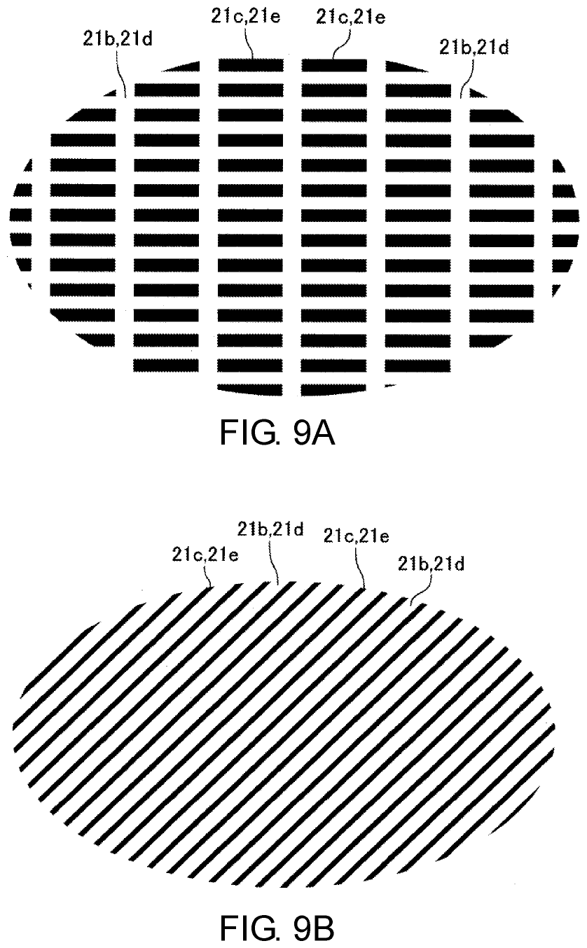

Furthermore, as shown in FIG. 9A, a plurality of ink adhering surfaces 21b (white parts in FIG. 9A) and a plurality of liquid repellent surfaces 21c (black parts in FIG. 9A) may be alternately arranged in the axial direction of the flattening roller 21 and may be alternately arranged in the circumferential direction of the flattening roller 21. That is, the ink adhering portions 21d and the non-ink adhering portions 21e may be alternately arranged in the axial direction of the flattening roller 21 and may be alternately arranged in the circumferential direction of the flattening roller 21.

Moreover, the ink adhering portions 21d and the non-ink adhering portions 21e may be alternately arranged only in the circumferential direction of the flattening roller 21. In this case, the ink adhering portions 21d and the non-ink adhering portions 21e are linearly formed along the axial direction of the flattening roller 21. Furthermore, in this case, a plurality of linear recesses 21a that lie along the axial direction of the flattening roller 21 are formed on the outer peripheral surface of the flattening roller 21.

Furthermore, as shown in FIG. 9B, a plurality of ink adhering surfaces 21b formed in a linear form (white parts in FIG. 9B) and a plurality of liquid repellent surfaces 21c (black parts in FIG. 9B) formed in a linear form may be alternately arranged in a direction inclined with respect to the axial direction of the flattening roller 21 and the circumferential direction of the flattening roller 21. That is, the ink adhering portions 21d and the non-ink adhering portions 21e may be alternately arranged in a direction inclined with respect to the axial direction of the flattening roller 21 and the circumferential direction of the flattening roller 21.

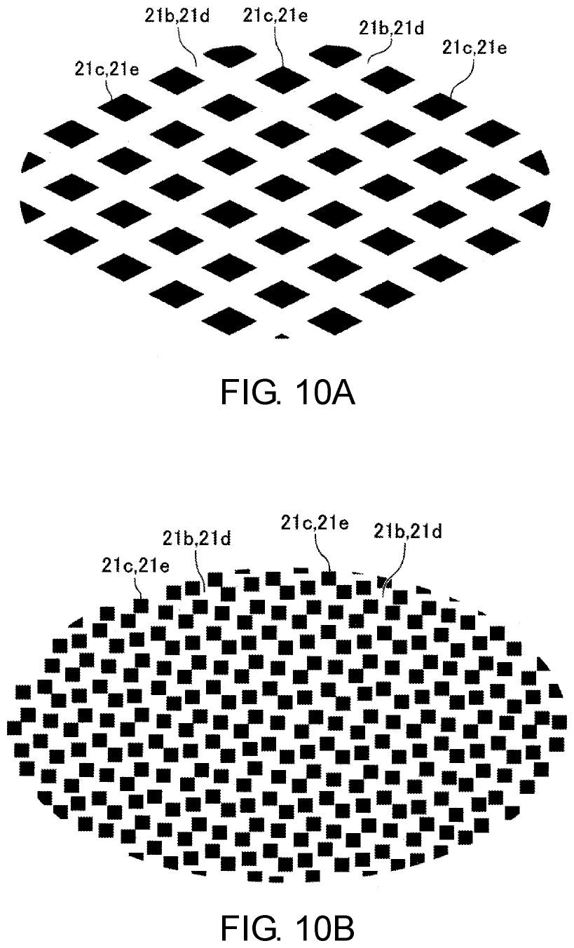

Furthermore, as shown in FIG. 10A, a plurality of liquid repellent surfaces 21c formed in a diamond shape (black parts in FIG. 10A) may be regularly arranged in the axial direction of the flattening roller 21 and the circumferential direction of the flattening roller 21. In other words, the non-ink adhering portions 21e formed in a diamond shape may be regularly arranged in the axial direction of the flattening roller 21 and the circumferential direction of the flattening roller 21. Moreover, as shown in FIG. 10B, a plurality of liquid repellent surfaces 21c (black parts in FIG. 10B) may be randomly arranged. That is, a plurality of non-ink adhering portions 21e may be randomly arranged.

In the modified example shown in FIG. 8B, the modified example shown in FIGS. 9A and 9B, and the modified example shown in FIG. 10A, the tip of the blade 24 that comes into contact with the outer peripheral surface of the flattening roller 21 when scraping off the ink adhered to the outer peripheral surface of the flattening roller 21 by the blade 24 contacts the ink adhering portion 21b in the entire region in the circumferential direction of the flattening roller 21. Therefore, in this modified example, it is possible to prevent the PTFE forming the liquid repellent surface 21c from being scraped off by the tip of the blade 24.

(Second Modified Example of Flattening Roller)

In the embodiments and modified examples described above, the recess 21a may not be filled with a material having liquid repellency. In this case, the recess 21a is the non-ink adhering portion 21e, and the cured ink does not adhere to the recess 21a even if the upper surface of the cured ink and the flattening roller 21 come into contact with each other when shaping the three-dimensional object 2 by the multi-pass method. That is, in this case, the ink adhering portion 21d including the ink adhering surface 21b and the non-ink adhering portion 21e from the recess 21c are formed on the outer peripheral surface of the flattening roller 21.

In this case, even if the upper surface of the cured ink and the outer peripheral surface of the flattening roller 21 come into contact with each other when shaping the three-dimensional object 2 by the multi-pass method, a part of the cured ink will not be scraped off by the non-ink adhering portion 21e. Therefore, even if the upper surface of the cured ink and the flattening roller 21 come into contact with each other, a part of the cured ink is less likely to be scraped off by the flattening roller 21. Therefore, even if the upper surface of the cured ink and the flattening roller 21 come into contact with each other, production of shavings can be further suppressed.

Furthermore, in this case as well, since the frictional force between the upper surface of the cured ink and the flattening roller 21 can be reduced, even if the upper surface of the cured ink and the flattening roller 21 come into contact with each other, generation of abnormal vibration of the flattening roller 21, deformation of the three-dimensional object 2 being shaped, and the separation from the shaping table 3 of the three-dimensional object 2 being shaped can be suppressed. Therefore, even when the three-dimensional object 2 is shaped by the multi-pass method and the upper surface of the cured ink and the flattening roller 21 come into contact with each other, the occurrence of shaping failures of the three-dimensional object 2 can be suppressed.

### OTHER EMBODIMENTS

The embodiment described above is an example of a preferred embodiment of the present disclosure, but the present disclosure is not limited thereto, and various modified examples can be made without changing the gist of the present disclosure.

In the embodiment described above, the liquid repellent surface 21c may be disposed on the inner side in the radial direction of the flattening roller 21 than the ink adhering surface 21b. Furthermore, in the embodiment described above, the flattening roller unit 22 may include, instead of the blade 24, a suction head that suctions and removes the ink adhered to the outer peripheral surface of the flattening roller 21 from the outer peripheral surface of the flattening roller 21. In this case, the suction port of the suction head is disposed while forming a gap with the outer peripheral surface of the flattening roller 21. The suction head in this case is the ink removing portion.

What is claimed is:

1. A shaping apparatus that shapes a three-dimensional object by a layered shaping method, the shaping apparatus comprising:
a shaping table on which the three-dimensional object is shaped;
an inkjet head that ejects an ink toward the shaping table;
a flattening roller that removes a part on an upper surface side of the ink ejected from the inkjet head to flatten an upper surface of the ink and adjust a thickness of an ink layer; and
an ink removing portion that removes the ink adhered to an outer peripheral surface of the flattening roller from the outer peripheral surface of the flattening roller;
wherein
on the outer peripheral surface of the flattening roller, an ink adhering portion including an ink adhering surface to which the ink adheres when flattening the upper surface of the ink, and a non-ink adhering portion including a liquid repellent surface which is a surface having liquid repellency are provided.

2. The shaping apparatus according to claim 1, wherein
the ink adhering surface and the liquid repellent surface are disposed on the same surface of the outer peripheral surface of the flattening roller.

3. The shaping apparatus according to claim 1, wherein
the ink adhering surface is a metal surface.

4. The shaping apparatus according to claim 1, wherein
on the outer peripheral surface of the flattening roller, the ink adhering portion and the non-ink adhering portion adjacent to each other are provided in a spiral shape along an axial direction of the flattening roller.

5. The shaping apparatus according to claim 1, wherein
the ink adhering portion and the non-ink adhering portion are arranged in a checkered pattern.

6. The shaping apparatus according to claim 1, wherein
the ink adhering portion and the non-ink adhering portion are alternately arranged in an axial direction of the flattening roller.

7. The shaping apparatus according to claim 1, wherein
the ink adhering portion and the non-ink adhering portion are alternately arranged in a circumferential direction of the flattening roller.

8. The shaping apparatus according to claim 1, further comprising:
at least two inkjet heads that eject different inks.

9. A shaping apparatus that shapes a three-dimensional object by a layered shaping method, the shaping apparatus comprising:
a shaping table on which the three-dimensional object is shaped;
an inkjet head that ejects an ink toward the shaping table;
a flattening roller that removes a part on an upper surface side of the ink ejected from the inkjet head to flatten an upper surface of the ink and adjust a thickness of an ink layer; and
an ink removing portion that removes the ink adhered to an outer peripheral surface of the flattening roller from the outer peripheral surface of the flattening roller;
wherein
on the outer peripheral surface of the flattening roller, an ink adhering portion including an ink adhering surface to which the ink adheres when flattening the upper surface of the ink, and a non-ink adhering portion including a recess that is depressed toward an inner side in a radial direction of the flattening roller are provided.

10. The shaping apparatus according to claim 9, wherein
the ink adhering surface is a metal surface.

11. The shaping apparatus according to claim 9, wherein
on the outer peripheral surface of the flattening roller, the ink adhering portion and the non-ink adhering portion adjacent to each other are provided in a spiral shape along an axial direction of the flattening roller.

12. The shaping apparatus according to claim 9, wherein
the ink adhering portion and the non-ink adhering portion are arranged in a checkered pattern.

13. The shaping apparatus according to claim 9, wherein
the ink adhering portion and the non-ink adhering portion are alternately arranged in an axial direction of the flattening roller.

14. The shaping apparatus according to claim 9, wherein
the ink adhering portion and the non-ink adhering portion are alternately arranged in a circumferential direction of the flattening roller.

15. The shaping apparatus according to claim 9, further comprising:
at least two inkjet heads that eject different inks.
